(19) United States
(12) Patent Application Publication
(10) Pub. No.: US 2013/0252560 A1
(43) Pub. Date: Sep. 26, 2013

(54) Antenna System with Spiral Antenna Sections and Applications Thereof

(71) Applicant: BROADCOM CORPORATION, IRVINE, CA (US)

(72) Inventors: Nicolaos G. Alexopoulos, Irvine, CA (US); Seunghwan Yoon, Costa Mesa, CA (US)

(73) Assignee: BROADCOM CORPORATION, IRVINE, CA (US)

(21) Appl. No.: 13/720,650

(22) Filed: Dec. 19, 2012

Related U.S. Application Data
(60) Provisional application No. 61/614,685, filed on Mar. 23, 2012.
(60) Provisional application No. 61/731,787, filed on Nov. 30, 2012.

(51) Int. Cl. H04B 7/005

(52) U.S. Cl. CPC H04B 7/005
USPC 455/73

(57) ABSTRACT

An antenna system includes an antenna structure and an antenna interface. The antenna structure includes ‘x’ number of spiral antenna sections. Each spiral antenna section transmits a different phase of ‘x’ phases of an outbound RF signal and receives a different phase of ‘x’ phases of an inbound RF signal. The antenna interface generates the ‘x’ phases of the outbound RF signal by splitting the outbound RF signal into ‘x’ copies and phase shifting each of the ‘x’ copies. The antenna interface also combines the ‘x’ phases of the inbound RF signal to produce the inbound RF signal by phase shifting each of the ‘x’ phases of the inbound RF signal by the respective phase shift and combining the ‘x’ copies.

### CROSS REFERENCE TO RELATED PATENTS

The present U.S. Utility patent application claims priority pursuant to 35 U.S.C. §119(e) to the following U.S. Provisional Applications which are incorporated herein by reference in their entirety and made part of the present U.S. Utility patent application for all purposes:
1. U.S. Provisional Application No. of 61/614,685, entitled “Parabolic Interwoven Assemblies and Applications Thereof,” filed Mar. 23, 2012, pending; and
2. U.S. Provisional Application No. 61/731,787, entitled “Antenna System with Spiral Antenna Sections and Applications Thereof,” filed Nov. 30, 2012, pending.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Technical Field of the Invention

This invention relates generally to wireless communication systems and more particularly to antenna structures used in such wireless communication systems.

2. Description of Related Art

Communication systems are known to support wireless and wire lined communications between wireless and/or wire lined communication devices. Such communication systems range from national and/or international cellular telephone systems to the Internet to point-to-point in-home wireless networks to radio frequency identification (RFID) systems to radio frequency radar systems. Each type of communication system is constructed, and hence operates, in accordance with one or more communication standards. For instance, radio frequency (RF) wireless communication systems may operate in accordance with one or more standards including, but not limited to, RFID, IEEE 802.11, Bluetooth, advanced mobile phone services (AMPS), digital AMPS, global system for mobile communications (GSM), code division multiple access (CDMA), WCDMA, local multi-point distribution systems (LMDS), multi-channel-multi-point distribution systems (MMDS), LTE, WiMAX, and/or variations thereof. As another example, infrared (IR) communication systems may operate in accordance with one or more standards including, but not limited to, IrDA (Infrared Data Association).

Since a wireless communication begins and ends with the antenna, a properly designed antenna structure is an important component of wireless communication devices. As is known, the antenna structure is designed to have a desired impedance (e.g., 50 Ohms) at an operating frequency, a desired bandwidth centered at the desired operating frequency, and a desired length (e.g., ¼ wavelength of the operating frequency for a monopole antenna). As is further known, the antenna structure may include a single monopole or dipole antenna, a diversity antenna structure, an antenna array having the same polarization, an antenna array having different polarization, and/or any number of other electro-magnetic properties.

### BRIEF DESCRIPTION OF THE SEVERAL VIEWS OF THE DRAWING(S)

FIG. 1 is a schematic block diagram of an embodiment of a wireless communication device in accordance with the present invention;

FIG. 2 is a schematic block diagram of an embodiment of an RF front-end module in accordance with the present invention;

FIG. 3 is a schematic block diagram of an embodiment of an antenna system in accordance with the present invention;

FIG. 4 is a schematic block diagram of an embodiment of an antenna interface in accordance with the present invention;

FIG. 5 is a schematic block diagram of another embodiment of an antenna interface in accordance with the present invention;

FIG. 6 is a schematic block diagram of another embodiment of an antenna interface in accordance with the present invention;

FIG. 7 is a schematic block diagram of another embodiment of an antenna interface in accordance with the present invention;

FIG. 8 is a schematic block diagram of an embodiment of a splitter-combiner unit in accordance with the present invention;

FIG. 9 is a schematic block diagram of another embodiment of a splitter-combiner unit in accordance with the present invention;

FIG. 10 is a schematic block diagram of another embodiment of an antenna interface in accordance with the present invention;

FIG. 11 is a schematic block diagram of an embodiment of an antenna system in accordance with the present invention;

FIG. 12 is a schematic block diagram of another embodiment of an antenna interface in accordance with the present invention;

FIG. 13 is a schematic block diagram of an embodiment of an antenna system in accordance with the present invention; and

FIG. 14 is a schematic block diagram of another embodiment of an antenna interface in accordance with the present invention.

### DETAILED DESCRIPTION OF THE INVENTION

FIG. 1 is a schematic block diagram of an embodiment of a wireless communication device 5 that includes a radio frequency (RF) front-end module 7, a power amplifier 15, a low noise amplifier 19, an up-conversion module 17, a down-conversion module 21, and a baseband processing module 23. The RF front-end module 7 includes an antenna system 11, a receive-transmit (RX-TX) isolation module 9, and a tuning module 13. The communication device 5 may be any device that can be carried by a person, can be at least partially powered by a battery, includes a radio transceiver (e.g., radio frequency (RF) and/or millimeter wave (MMW)) and performs one or more software applications. For example, the communication device 5 may be a cellular telephone, a laptop computer, a personal digital assistant, a video game console, a video game player, a personal entertainment unit, a tablet computer, etc.

In an example of transmitting an outbound RF signal, the baseband processing module 23 converts outbound data (e.g., voice, text, video, graphics, video file, audio file, etc.) into one or more streams of outbound symbols in accordance with a communication standard, or protocol. The up-conversion module 17, which may be a direct conversion module or a super heterodyne conversion module, converts the one or more streams of outbound symbols into one or more up-converted signals. The power amplifier 15 amplifies the one or more up-converted signals to produce one or more outbound RF signals. The RX-TX isolation module 9 isolates the outbound RF signal(s) from inbound RF signal(s) and provides the outbound RF signal(s) to the antenna system 11 for transmission. Note that the tuning module 13 tunes the RX-TX isolation module 9.

In an example of receiving one or more inbound RF signals, the antenna system 11 receives the inbound RF signal(s) and provides them to the RX-TX isolation module 9. The RX-TX isolation module 9 isolates the inbound RF signal(s) from the outbound RF signal(s) and provides the inbound RF signal(s) to the low noise amplifier 19. The low noise amplifier 19 amplifies the inbound RF signal(s) and the down-conversion module 21, which may be a direct down conversion module or a super heterodyne conversion module, converts the amplified inbound RF signal(s) into one or more streams of inbound symbols. The baseband processing module 23 converts the one or more streams of inbound symbols into inbound data.

The RF front-end module 7 may be implemented as an integrated circuit (IC) that includes one or more IC dies and an IC package substrate. The tuning module 13 is implemented on the one or more IC dies. The IC package substrate supports the IC die(s) and may further include the antenna system 11, or a portion thereof The RX-TX isolation module 9 may be implemented on the one or more IC dies and/or on the IC package substrate. One or more of the power amplifier 15, the low noise amplifier 19, the up-conversion module 17, the down-conversion module 21, and the baseband processing module 23 may be implemented on the one or more IC dies.

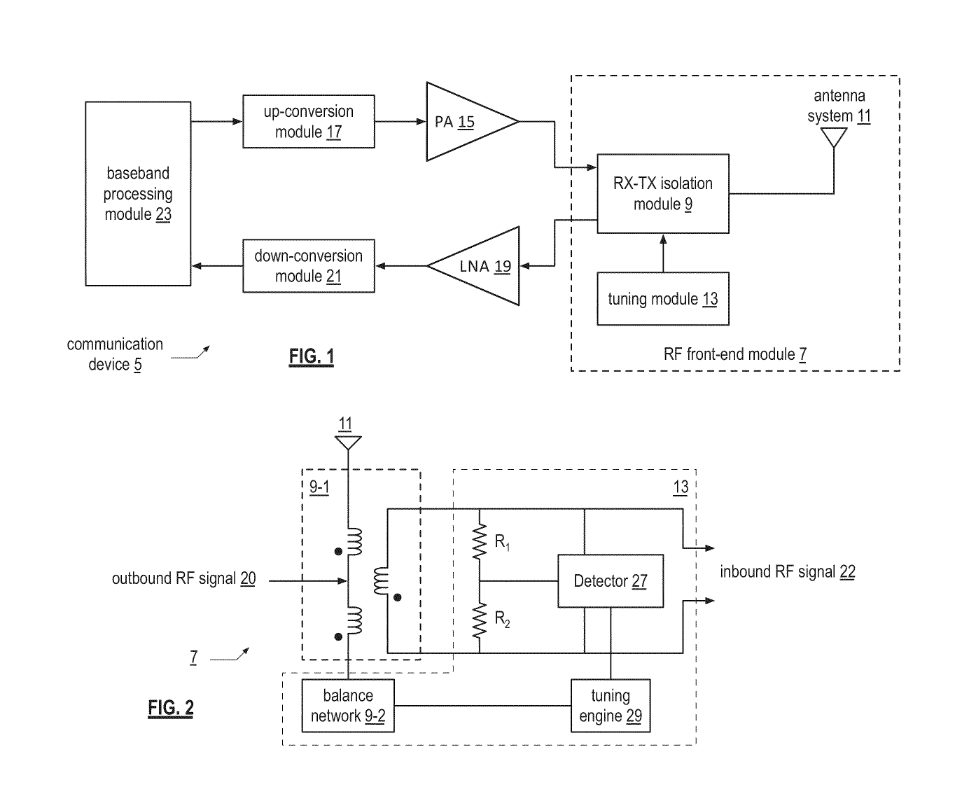

FIG. 2 is a schematic block diagram of an embodiment of an RF front-end module 7 that includes the antenna system 11, a duplexer 9-1 and a balance network 9-2 as the RX-TX isolation module 9, and a resistor divider (R1 and R2), a detector 27, and a tuning engine 29 as the tuning module 13. The duplexer 9-1 ideally functions, with respect to the secondary winding, to add the voltage induced by the inbound RF signal on the two primary windings and to subtract the voltage induced by the outbound RF signal on the two primary windings such that no outbound RF signal is present on the secondary winding and that two times the inbound RF signal is present on the secondary winding. The balance network 9-2 adjusts its impedance based on feedback from the tuning module 13 to substantially match the impedance of the antenna system 11 such that the duplexer functions more closely to ideal.

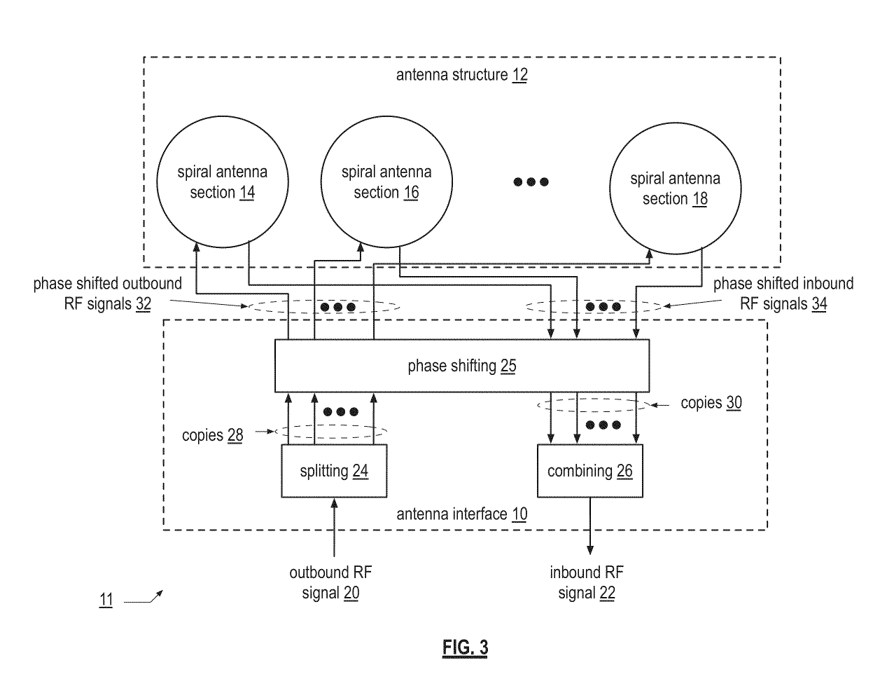

FIG. 3 is a schematic block diagram of an embodiment of an antenna system 11 that includes an antenna interface 10 and an antenna structure 12. The antenna structure includes ‘x’ number of spiral antenna sections 14-18, where ‘x’ is an integer greater than or equal to two. Each of the spiral antenna sections 14-18 includes one or more spiral elements and may be implemented on a two-dimensional surface or a three-dimensional shape as discussed in co-pending patent applications: entitled THREE-DIMENSIONAL SPIRAL ANTENNA AND APPLICATIONS THEREOF, having a filing date of [TBD], a Ser. No. of [TBD], and an attorney docket number of BP30814 and entitled THREE-DIMENSIONAL MULTIPLE SPIRAL ANTENNA AND APPLICATIONS THEREOF, having a filing date of [TBD], a Ser. No. of [TBD], and an attorney docket number of BP30815; both of which are incorporated herein by reference.

The antenna interface 10 includes modules for splitting 24, combining 26, and phase shifting 25. The splitting module 24 splits an outbound radio frequency (RF) signal 20 into ‘x’ copies 28 of the outbound RF signal 20. The phase shifting module 25 phase shifts each of the ‘x’ copies of the outbound RF signal by a respective phase shift to produce ‘x’ phases of the outbound RF signal 32, which are transmitted by the spiral antenna sections 14-18.

The spiral antenna sections 14-18 receive a different phase of ‘x’ phases of the inbound RF signal 34 and provides them to the phase shifting module 25, which phase shifts each of the ‘x’ phases of the inbound RF signal 34 by the respective phase shift to produce ‘x’ copies 30 of the inbound RF signal 22. The combining module 26 combines the ‘x’ copies of the inbound RF signal into the inbound RF signal 22.

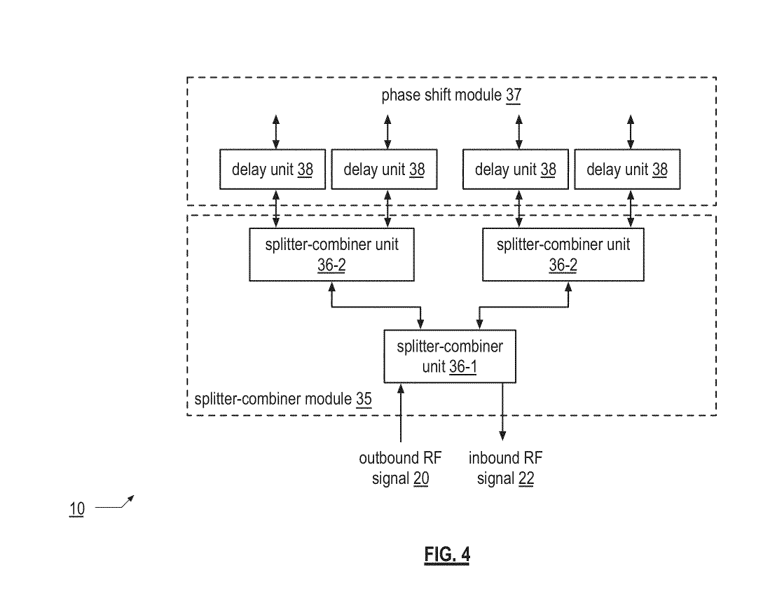

FIG. 4 is a schematic block diagram of an embodiment of an antenna interface 10 that includes a splitter-combiner module 35 and a phase shift module 37. The splitter-combiner module 35 includes a first layer splitter-combiner unit 36-1 and a pair of second layer splitter-combiner units 36-2. The phase shift module 37 includes phase delay units 38, which may be inverted based delay lines, microstrip delay lines, adjustable delay lines, etc.

In an example of operation for transmitting an outbound RF signal, the first layer splitter-combiner unit 36-1 splits the outbound RF signal 20 into a pair of first layer copies of the outbound RF signal. Each of the second layer splitter-combiner units 36-2 splits a respective one of the first layer copies of the outbound RF signal into a pair of respective second layer copies of the outbound RF signal. Each of the phase delay units 38 phase shifts a corresponding one of the copies of the outbound RF signal by a respective phase delay to produce corresponding ones of the ‘x’ phases of the outbound RF signal, which are transmitted by the spiral antenna sections 14-18.

In an example of operation for receiving an inbound RF signal, each of the phase delay units phase shifts corresponding ones of the ‘x’ phases of the inbound RF signal by a respective phase delay to produce corresponding ones of the ‘x’ copies of the inbound RF signal. Each of the second layer splitter-combiner units 36-2 combines a respective pair of second layer copies of the ‘x’ copies of the inbound RF signal into respective ones of a pair of first layer copies of the ‘x’ copies of the inbound RF signal. The first layer splitter-combiner unit 36-1 combines the respective ones of pair of first layer copies of the ‘x’ copies of the inbound RF signal into the inbound RF signal 22.

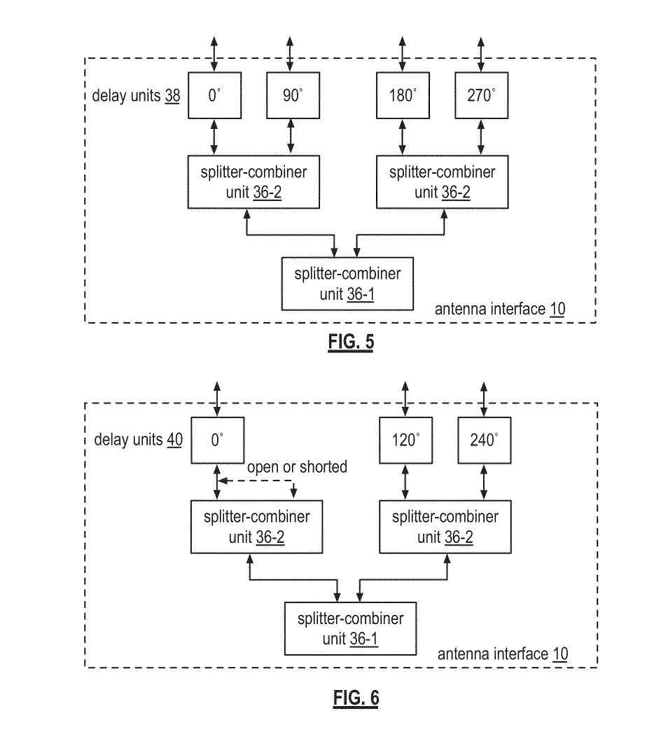

FIG. 5 is a schematic block diagram of another embodiment of an antenna interface 10 that includes a splitter-combiner module 35 and a phase shift module 37. The splitter-combiner module 35 includes a first layer splitter-combiner unit 36-1 and a pair of second layer splitter-combiner units 36-2. The phase shift module 37 includes a 0° phase delay unit 38, a 90° phase delay unit 38, a 180° phase delay unit 38, and a 270° phase delay unit 38.

In this embodiment, the splitter-combiner units 36-1 and 36-2 create four copies of the outbound RF signal. The phase delay units 38 phase shift a copy of the outbound RF signal by a respective phase shift. For example, the 0° phase delay unit 38 phase shifts a copy of the outbound RF signal by 0°; the 90° phase delay unit 38 phase shifts a copy of the outbound RF signal by 90°; the 180° phase delay unit 38 phase shifts a copy of the outbound RF signal by 180°; and the 270° phase delay unit 38 phase shifts a copy of the outbound RF signal by 270°. The phase delay units 38 perform a similar phase shift on the phase shifted inbound RF signals to produce copies of the inbound RF signal.

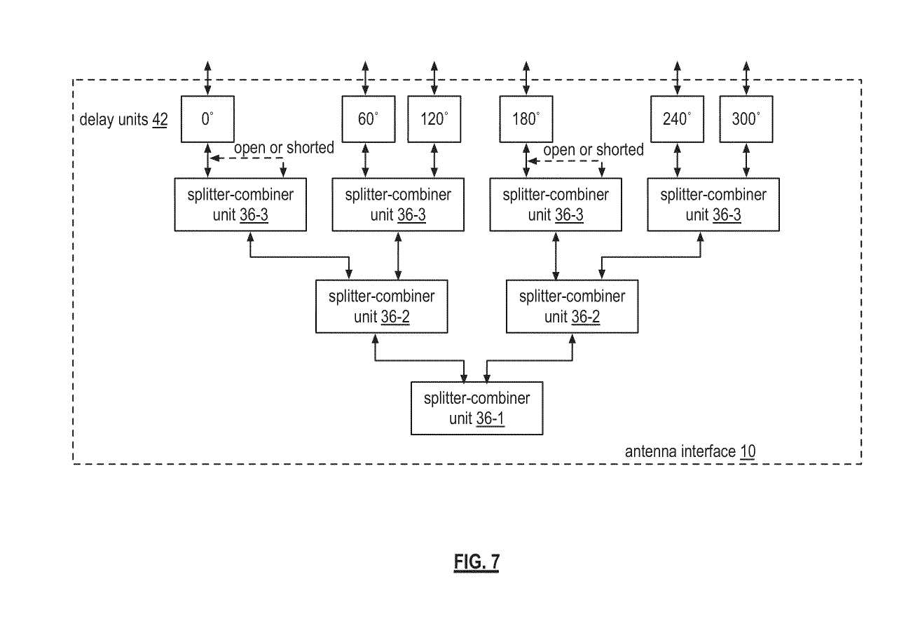

FIG. 6 is a schematic block diagram of another embodiment of an antenna interface 10 that includes a splitter-combiner module 35 and a phase shift module 37. The splitter-combiner module 35 includes a first layer splitter-combiner unit 36-1 and a pair of second layer splitter-combiner units 36-2. The phase shift module 37 includes a 0° phase delay unit 40, a 120° phase delay unit 40, and a 240° phase delay unit 40.

In this embodiment, the splitter-combiner units 36-1 and 36-2 create three copies of the outbound RF signal. The phase delay units 40 phase shift three copies of the outbound RF signal by a respective phase shift. For example, the 0° phase delay unit 40 phase shifts a copy of the outbound RF signal by 0°; the 120° phase delay unit 40 phase shifts a copy of the outbound RF signal by 120°; and the 240° phase delay unit 40 phase shifts a copy of the outbound RF signal by 240°. The phase delay units 40 perform a similar phase shift on the phase shifted inbound RF signals to produce copies of the inbound RF signal. Note that the second copy of the inbound or outbound RF signal of one of the second layer splitter-combiner units 36-2 may be left open (i.e., unused) or it may be coupled to the other copy (e.g., shorted).

FIG. 7 is a schematic block diagram of another embodiment of an antenna interface 10 that includes a splitter-combiner module 35 and a phase shift module 37. The splitter-combiner module 35 includes a first layer splitter-combiner unit 36-1, second layer splitter-combiner units 36-2, and third layer splitter-combiner units 36-3. The phase shift module 37 includes a 0° phase delay unit 42, a 60° phase delay unit 42, a 120° phase delay unit 42, a 180° phase delay unit 42, a 240° phase delay unit 42, and a 300° phase delay unit 42.

In this embodiment, the splitter-combiner units 36-1, 36-2, and 36-3 create eight copies of the outbound RF signal. The phase delay units 42 phase shift six copies of the outbound RF signal by a respective phase shift. For example, the 0° phase delay unit 42 phase shifts a copy of the outbound RF signal by 0°; the 60°phase delay unit 42 phase shifts a copy of the outbound RF signal by 60°; the 120° phase delay unit 42 phase shifts a copy of the outbound RF signal by 120°; the 180° phase delay unit 42 phase shifts a copy of the outbound RF signal by 180°; the 240° phase delay unit 42 phase shifts a copy of the outbound RF signal by 240°; and the 300° phase delay unit 42 phase shifts a copy of the outbound RF signal by 300°. The phase delay units 42 perform a similar phase shift on the phase shifted inbound RF signals to produce copies of the inbound RF signal. Note that the second copy of the inbound or outbound RF signal of two of the third layer splitter-combiner units 36-3 may be left open (i.e., unused) or it may be coupled to the other copy (e.g., shorted).

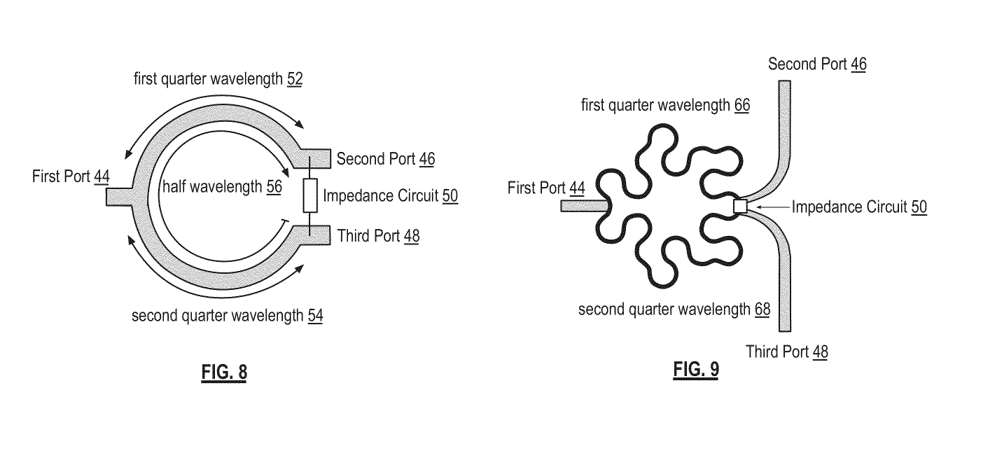

FIG. 8 is a schematic block diagram of an embodiment of a splitter-combiner unit 36-1, 36-2, or 36-3 that includes a first port 44, a second port 46, a third port 48, a first quarter wavelength section 52, a second quarter wavelength section 54, and an impedance circuit 50. The RF signal (inbound or outbound) on the first port 44 is duplicated (or copied) on each of the second and third ports 46 and 48. Each quarter wavelength section 52 and 54 have an impedance of √2*Zₒ and the impedance circuit 50 has an impedance of 2*Zₒ. The impedance circuit 50, which is coupled between the second and third ports 46 and 48 may include one or more resistors, one or more capacitors, and/or one or more inductors.

FIG. 9 is a schematic block diagram of another embodiment of a splitter-combiner unit 36-1, 36-2, or 36-3 that includes a first port 44, a second port 46, a third port 48, a first quarter wavelength section 66, a second quarter wavelength section 68, and an impedance circuit 50. In this embodiment, the first quarter wavelength section 66 has a meandering pattern and the second quarter wavelength section 68 has a mirroring meandering pattern, which reduces the footprint of the splitter-combiner unit.

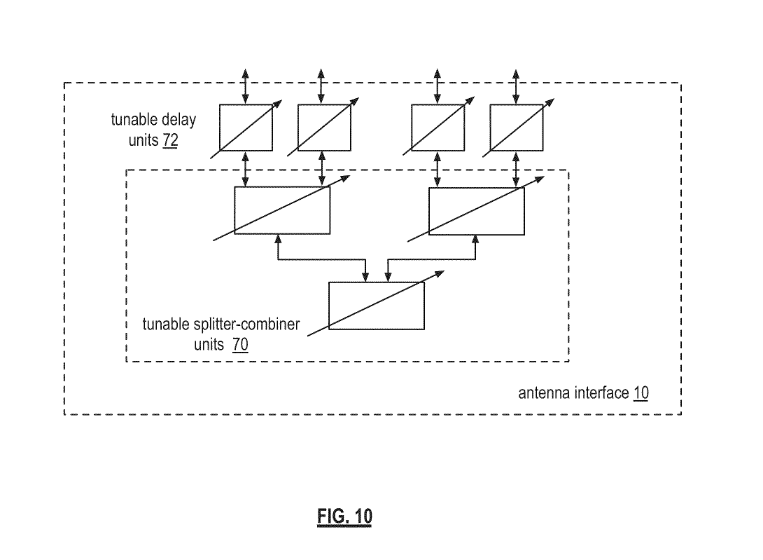

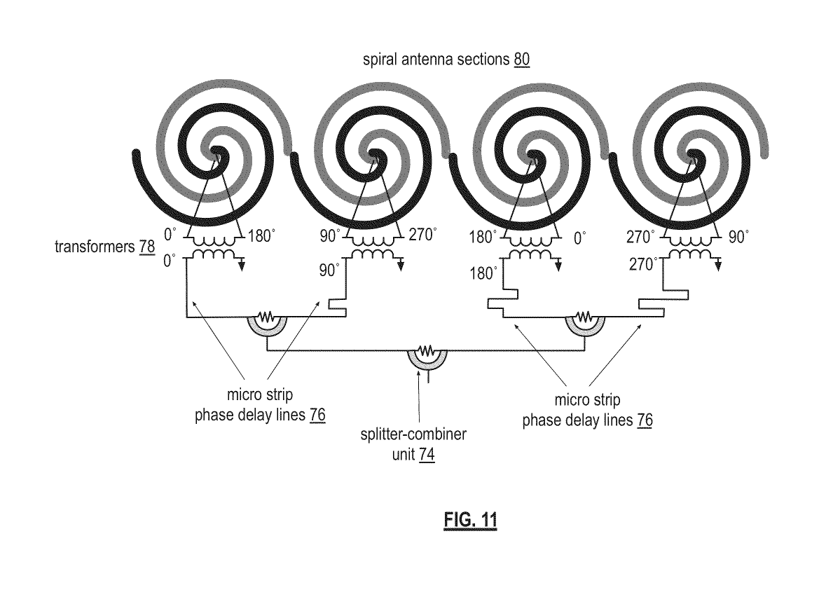

FIG. 10 is a schematic block diagram of another embodiment of an antenna interface 10 that includes tunable splitter-combiner units 70 and tunable delay units 72. Each of the tunable splitter-combiner units 70 is constructed similarly the units of FIGS. 8 and/or 9. In the present embodiment, the impedance circuit is tunable, the first quarter wavelength section is tunable, and/or the second quarter wavelength section is tunable. Each of the tunable delay units 72 includes a delay line that is tunable. Tuning of one or more of the quarter wavelength sections, the impedance circuit, and/or the delay lines may be done by adjusting an inductor-capacitor network or a resistor-inductor-capacitor network coupled to, or part of, the particular element being tuned.

FIG. 11 is a schematic block diagram of an embodiment of an antenna system 11 that includes four spiral antenna sections 80, transformers 78, splitter-combiner units 74, and microstrip phase delay lines 76 to provide, for a given frequency range, a 0° phase shift, a 90° phase shift, a 180° phase shift, and a 270° phase shift. Each of the spiral antenna sections 80 is a spiral dipole antenna that includes a dipole feed point at the end of the inner windings of its interwoven windings. The dipole feed point of each spiral antenna section 80 is coupled to a corresponding transformer 78, which is functioning as a transformer balun to convert between single-ended signals and differential signals. The antenna interface of the antenna system 11 operates similarly to the antenna interface discussed with reference to FIG. 5.

Each of the spiral dipole antenna sections 80 transmits a differential representation of one of the phase shifted copies of the outbound RF signal, wherein the transformers convert a singled-ended representation of the phase shifted copies of the outbound RF signal into the differential representations. Each of the spiral dipole antenna sections 80 also receives a differential representation of one of the phase shifted copies of the inbound RF signal, wherein the transformers convert the differential representations of the phase shifted copies of the inbound RF signal into single-ended representations.

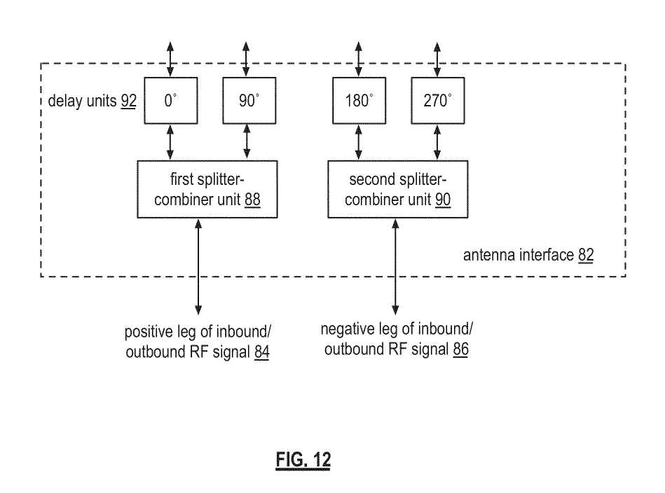

FIG. 12 is a schematic block diagram of another embodiment of an antenna interface of an antenna interface 10 that includes a splitter-combiner module and a phase shift module. The splitter-combiner module includes a first splitter-combiner unit 88 and a second splitter-combiner unit 90. The phase shift module includes a 0° phase delay unit 92, a 90° phase delay unit 92, a 180° phase delay unit 92, and a 270° phase delay unit 92.

In this embodiment, the splitter-combiner units 88 and 90 (which may be similar to units 36) create four copies of the outbound RF signal from the positive leg and negative leg of a differential outbound RF signal. The phase delay units 92 (which may be similar to units 38) phase shift a copy of the outbound RF signal by a respective phase shift. For example, the 0° phase delay unit 38 phase shifts a copy of the outbound RF signal by 0°; the 90° phase delay unit 38 phase shifts a copy of the outbound RF signal by 90°; the 180° phase delay unit 38 phase shifts a copy of the outbound RF signal by 180°; and the 270° phase delay unit 38 phase shifts a copy of the outbound RF signal by 270°. The phase delay units 38 perform a similar phase shift on the phase shifted inbound RF signals to produce copies of the inbound RF signal.

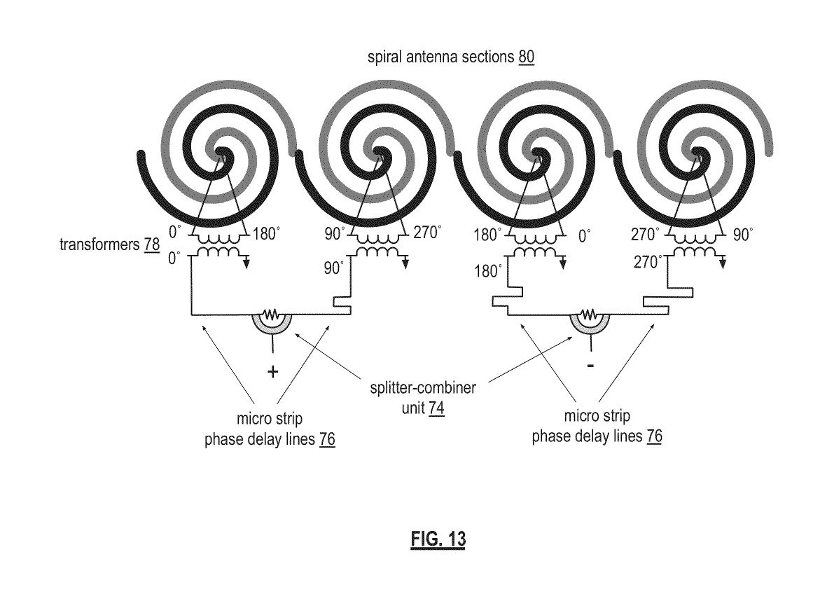

FIG. 13 is a schematic block diagram of an embodiment of an antenna system 11 that includes four spiral antenna sections 80, transformers 78, splitter-combiner units 74, and microstrip phase delay lines 76 to provide, for a given frequency range, a 0° phase shift, a 90° phase shift, a 180° phase shift, and a 270° phase shift. Each of the spiral antenna sections 80 is a spiral dipole antenna that includes a dipole feed point at the end of the inner windings of its interwoven windings. The dipole feed point of each spiral antenna section 80 is coupled to a corresponding transformer 78, which is functioning as a transformer balun to convert between single-ended signals and differential signals. The antenna interface of the antenna system 11 operates similarly to the antenna interface discussed with reference to FIG. 12 by converting a differential RF signal into four single-end copies of the RF signal.

Each of the spiral dipole antenna sections 80 transmits a differential representation of one of the phase shifted copies of the outbound RF signal, wherein the transformers convert a singled-ended representation of the phase shifted copies of the outbound RF signal into the differential representations. Each of the spiral dipole antenna sections 80 also receives a differential representation of one of the phase shifted copies of the inbound RF signal, wherein the transformers convert the differential representations of the phase shifted copies of the inbound RF signal into single-ended representations.

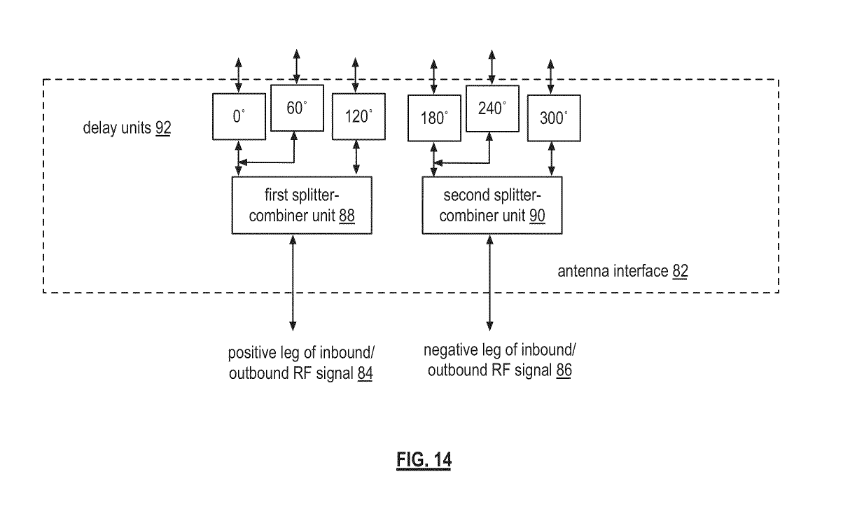

FIG. 14 is a schematic block diagram of another embodiment of an antenna interface 10 that includes a splitter-combiner module and a phase shift module. The splitter-combiner module includes a first splitter-combiner unit 88 and a second splitter-combiner unit 90. The phase shift module includes a 0° phase delay unit 92, a 60° phase delay unit 92, a 120° phase delay unit 92, a 180° phase delay unit 92, a 240° phase delay unit 92, and a 300° phase delay unit 92.

In this embodiment, the splitter-combiner units 88 and 90 (which may be similar to units 36) create four copies of the outbound RF signal from the positive leg and negative leg of a differential outbound RF signal. The phase delay units 92 (which may be similar to units 38) phase shift a copy of the outbound RF signal by a respective phase shift. For example, the 0° and the 60° phase delay units 38 each phase shifts the same copy of the outbound RF signal by 0° and 60°, respectively; the 120° phase delay unit 38 phase shifts a copy of the outbound RF signal by 120°; the 180° and 240° phase delay units 38 each phase shifts the same copy of the outbound RF signal by 180° and 240°, respectively; and the 300° phase delay unit 38 phase shifts a copy of the outbound RF signal by 300°. The phase delay units 38 perform a similar phase shift on the phase shifted inbound RF signals to produce copies of the inbound RF signal.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a processing module, a functional block, hardware, and/or software stored on memory for performing one or more functions as may be described herein. Note that, if the module is implemented via hardware, the hardware may operate independently and/or in conjunction software and/or firmware. As used herein, a module may contain one or more sub-modules, each of which may be one or more modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. An antenna system comprises:
an antenna structure that includes ‘x’ number of spiral antenna sections, each spiral antenna section of the ‘x’ number of spiral antenna sections transmits a different phase of ‘x’ phases of an outbound radio frequency (RF) signal and provides a different phase of ‘x’ phases of an inbound RF signal, wherein ‘x’ is an integer greater than or equal to two; and
an antenna interface operable to:
generate the ‘x’ phases of the outbound RF signal by:
splitting the outbound RF signal into ‘x’ copies of the outbound RF signal; and
phase shifting each of the ‘x’ copies of the outbound RF signal by a respective phase shift to produce the ‘x’ phases of the outbound RF signal; and
combine the ‘x’ phases of the inbound RF signal by:
phase shifting each of the ‘x’ phases of the inbound RF signal by the respective phase shift to produce ‘x’ copies of the inbound RF signal; and
combining the ‘x’ copies of the inbound RF signal to produce the inbound RF signal.

2. The antenna system of claim 1, wherein the antenna interface comprises:
a splitter-combiner module including:
a first layer splitter-combiner unit that is operable to:
split the outbound RF signal into a pair of first layer copies of the ‘x’ number of copies of the outbound RF signal; and
combine a pair of first layer copies of the ‘x’ copies of the inbound RF signal into the inbound RF signal;
a pair of second layer splitter-combiner units, wherein each of the pair of second layer splitter-combiner units is operable to:
split a respective one of the pair of first layer copies of the ‘x’ number of copies of the outbound RF signal into a pair of respective second layer copies of the ‘x’ number of copies of the outbound RF signal; and
combine a respective pair of second layer copies of the ‘x’ copies of the inbound RF signal into a respective one of the pair of first layer copies of the ‘x’ copies of the inbound RF signal; and
a phase shifting module operably coupled to the splitter-combiner module, wherein the phase shifting module includes a plurality of phase delay units, wherein:
a first delay unit of the plurality of phase delay units is operable to:
phase shifting a first one of the ‘x’ copies of the outbound RF signal by a first phase delay to produce a first one of the ‘x’ phases of the outbound RF signal; and
phase shifting a first one of the ‘x’ phases of the inbound RF signal by the first delay to produce a first one of the ‘x’ copies of the inbound RF signal.

3. The antenna system of claim 2, wherein a splitter-combiner unit of the first layer splitter-combiner unit and of the pair of second layer splitter-combiner units comprises:
a first port;
a second port;
a third port;
an impedance circuit coupled between the second and third ports;
a first quarter wavelength section coupled to the first port and the second port; and
a second quarter wavelength section coupled to the first port and the third port, wherein the second and third ports convey a copy of an RF signal on the first port.

4. The antenna system of claim 3 further comprises:
the first quarter wavelength section having a meandering pattern; and
the second quarter wavelength section having a mirroring meandering pattern, wherein impedance of each of the first and second quarter wavelength sections is a square root of two times a nominal impedance, and wherein impedance of the impedance circuit element is two times the nominal impedance.

5. The antenna system of claim 2, wherein the first delay unit comprises:
a micro strip phase delay line to provide the first phase delay for a given frequency range.

6. The antenna system of claim 2 further comprises:
a splitter-combiner unit of the first layer splitter-combiner unit and of the pair of second layer splitter-combiner units includes:
a first port;
a second port;
a third port;
a tunable impedance circuit element coupled between the second and third ports;
a tunable first quarter wavelength section coupled to the first port and the second port; and
a tunable second quarter wavelength section coupled to the first port and the third port, wherein the second and third ports convey a copy of an RF signal on the first port; and
the first delay unit including a tunable phase delay line that is adjustable to maintain the first phase delay substantially constant over a broadband frequency range.

7. The antenna system of claim 1 further comprises:
the antenna structure including four spiral antenna sections, wherein the ‘x’ phases of the outbound RF signal include a zero degree outbound RF signal, a ninety degree outbound RF signal, a one hundred eighty degree outbound RF signal, and a two hundred seventy degree outbound RF signal, and wherein the ‘x’ phases of an inbound RF signal include a zero degree inbound RF signal, a ninety degree inbound RF signal, a one hundred eighty degree inbound RF signal, and a two hundred seventy degree inbound RF signal; and
the antenna interface including:
a first splitter-combiner unit operable to:
split the outbound RF signal into a pair of first layer copies of the ‘x’ number of copies of the outbound RF signal; and
combine a pair of first layer copies of the ‘x’ copies of the inbound RF signal into the inbound RF signal;
a second splitter-combiner unit operable to:
split a first one of the pair of first layer copies of the ‘x’ number of copies of the outbound RF signal into a first pair of second layer copies of the ‘x’ number of copies of the outbound RF signal; and
combine a first pair of second layer copies of the ‘x’ copies of the inbound RF signal into a first one of the pair of first layer copies of the ‘x’ copies of the inbound RF signal; and
a third splitter-combiner unit operable to:
split a second one of the pair of first layer copies of the ‘x’ number of copies of the outbound RF signal into a second pair of second layer copies of the ‘x’ number of copies of the outbound RF signal; and
combine a second pair of second layer copies of the ‘x’ copies of the inbound RF signal into a second one of the pair of first layer copies of the ‘x’ copies of the inbound RF signal, wherein the first and second pairs of second layer copies of the ‘x’ number of copies of the outbound RF signal constitutes four copies of the outbound RF signal and wherein the first and second pairs of second layer copies of the ‘x’ number of copies of the inbound RF signal constitutes four copies of the inbound RF signal;
a ninety degree delay unit operable to:
phase shift by ninety degrees a second copy of the four copies of the outbound RF to produce the ninety degree outbound RF signal; and
phase shift by ninety degrees the ninety degree inbound RF signal to produce a second copy of the four copies of the inbound RF signal;
a one hundred eighty degree delay unit operable to:
phase shift by one hundred eighty degrees a third copy of the four copies of the outbound RF to produce the one hundred eighty degree outbound RF signal; and
phase shift by one hundred eighty degrees the one hundred eighty degree inbound RF signal to produce a third copy of the four copies of the inbound RF signal; and
a two hundred seventy degree delay unit operable to:
phase shift by two hundred seventy degrees a fourth copy of the four copies of the outbound RF to produce the two hundred seventy degree outbound RF signal; and
phase shift by two hundred seventy degrees the two hundred seventy degree inbound RF signal to produce a fourth copy of the four copies of the inbound RF signal, wherein a first copy of the outbound RF signal corresponds to the zero degree outbound RF signal and a first copy of the inbound RF signal corresponds to the zero degree inbound RF signal.

8. The antenna system of claim 1 further comprises:
the antenna structure including four spiral antenna sections, wherein the ‘x’ phases of the outbound RF signal include a zero degree outbound RF signal, a ninety degree outbound RF signal, a one hundred eighty degree outbound RF signal, and a two hundred seventy degree outbound RF signal, and wherein the ‘x’ phases of an inbound RF signal include a zero degree inbound RF signal, a ninety degree inbound RF signal, a one hundred eighty degree inbound RF signal, and a two hundred seventy degree inbound RF signal; and
the antenna interface including:
a first splitter-combiner unit operable to:
split a positive leg of the outbound RF signal into a first pair of copies of four copies of the outbound RF signal; and
combine a first pair of copies of four copies of the inbound RF signal into a positive leg of the inbound RF signal;
a second splitter-combiner unit operable to:
split a negative leg of the outbound RF signal into a second pair of copies of four copies of the outbound RF signal; and
combine a second pair of copies of four copies of the inbound RF signal into a negative leg of the inbound RF signal; and
a first ninety degree delay unit operable to:
phase shift by ninety degrees a second copy of the first pair of copies of the outbound RF to produce the ninety degree outbound RF signal; and
phase shift by ninety degrees the ninety degree inbound RF signal to produce a second copy of the first pair copies of the inbound RF signal;
a second ninety degree delay unit operable to:
phase shift by ninety degrees a second copy of the second pair of copies of the outbound RF signal to produce the two hundred seventy degree outbound RF signal; and
phase shift by ninety degrees the two hundred seventy degree inbound RF signal to produce a second copy of the second pair copies of the inbound RF signal, wherein a first copy of the first pair of copies of the outbound RF signal corresponds to the zero degree outbound RF signal, a first copy of the first pair of the inbound RF signal corresponds to the zero degree inbound RF signal, wherein a first copy of the second pair of copies of the outbound RF signal corresponds to the one hundred eighty degree outbound RF signal, and a first copy of the second pair of the inbound RF signal corresponds to the one hundred eighty degree inbound RF signal.

9. The antenna system of claim 1, wherein the antenna interface comprises:
‘x’ number of transformers operably coupled to the ‘x’ number of spiral antenna sections, wherein the ‘x’ number of transformers provides the ‘x’ phases of the outbound RF signal to the ‘x’ number of spiral antenna sections and receives the ‘x’ phases of the inbound RF signal from the x′ number of spiral antenna sections;
a plurality of delay units operable to:
phase shift each of the ‘x’ copies of the outbound RF signal by the respective phase shift to produce the ‘x’ phases of the outbound RF signal; and
phase shift each of the ‘x’ phases of the inbound RF signal by the respective phase shift to produce ‘x’ copies of the inbound RF signal;
a plurality of splitter-combiner units operable to:
split the outbound RF signal into ‘x’ copies of the outbound RF signal; and
combine the ‘x’ copies of the inbound RF signal to produce the inbound RF signal.

10. An antenna system comprises:
an antenna structure that includes ‘x’ number of dipole spiral antenna sections, each dipole spiral antenna section of the ‘x’ number of dipole spiral antenna sections includes a first spiral element and a second spiral element, transmits a different differential phase shifted representation of an outbound radio frequency (RF) signal, and receives a different differential phase representation of an inbound RF signal, wherein ‘x’ is an integer greater than or equal to two; and
an antenna interface that includes:
‘x’ number of transformers operably coupled to the ‘x’ number of dipole spiral antenna sections, wherein the ‘x’ number of transformers provides the phase shifted representations of the outbound RF signal to the ‘x’ number of spiral antenna sections and receives the ‘x’ phases of an inbound RF signal from the x′ number of spiral antenna sections;
a first splitter-combiner unit operable to:
split a positive leg of the outbound RF signal into a pair of copies of the positive leg of the outbound RF signal; and
combine a pair of copies of a positive leg of the inbound RF signal into the positive leg of the inbound RF signal;
a second splitter-combiner unit operable to:
split a negative leg of the outbound RF signal into a pair of copies of the negative leg of the outbound RF signal; and
combine a pair of copies of a negative leg of the inbound RF signal into the negative leg of the inbound RF signal; and
a plurality of delay units operable to:
phase shift the pair of copies of the positive leg of the outbound RF signal and the pair of copies of the negative leg of the outbound RF signal to produce the phase shifted representations of the outbound RF signal; and
phase shift the pair of copies of the positive leg of the inbound RF signal and the pair of copies of the negative leg of the inbound RF signal to produce the phase shifted representations of the inbound RF signal.

11. The antenna system of claim 10 further comprises:
each of the first and second splitter-combiner units including:
a first port;
a second port;
a third port;
an impedance circuit element coupled between the second and third ports;
a first quarter wavelength section coupled to the first port and the second port; and
a second quarter wavelength section coupled to the first port and the third port, wherein the second and third ports convey a copy of an RF signal on the first port; and
a delay unit of the plurality of delay units including a micro strip phase delay line to provide a phase delay for a given frequency range.

12. The antenna system of claim 10 further comprises:
each of the first and second splitter-combiner units includes:
a first port;
a second port;
a third port;
a tunable impedance circuit element coupled between the second and third ports;
a tunable first quarter wavelength section coupled to the first port and the second port; and
a tunable second quarter wavelength section coupled to the first port and the third port, wherein the second and third ports convey a copy of an RF signal on the first port; and
a first delay unit of the plurality of delay units including a tunable phase delay line that is adjustable to maintain a phase delay substantially constant over a broadband frequency range.

13. The antenna system of claim 10 further comprises:
the antenna structure including four dipole spiral antenna sections; and
the plurality of delay units including a first delay unit and a second delay unit, wherein the first delay unit is operable to:
phase shift one of the pair of copies of the positive leg of the outbound RF signal to produce a ninety degree phase shifted representation of the outbound RF signal; and
phase shift one of the pair of copies of the positive leg of the inbound RF signal to produce a ninety degree phase shifted representation of the inbound RF signal;
wherein the second delay unit is operable to:
phase shift one of the pair of copies of the negative leg of the outbound RF signal to produce a two hundred seventy degree phase shifted representation of the outbound RF signal; and
phase shift one of the pair of copies of the negative leg of the inbound RF signal to produce a two hundred seventy degree phase shifted representation of the inbound RF signal, wherein the other one of the pair of copies of the positive leg of the outbound RF signal provides a zero degree phase shifted representation of the outbound RF signal;
wherein the other one of the pair of copies of the negative leg of the outbound RF signal provides a one hundred eighty degree phase shifted representation of the outbound RF signal, wherein the other one of the pair of copies of the positive leg of the inbound RF signal provides a zero degree phase shifted representation of the inbound RF signal, and wherein the other one of the pair of copies of the negative leg of the inbound RF signal provides a one hundred eighty degree phase shifted representation of the inbound RF signal.

14. The antenna system of claim 10 further comprises:
the antenna structure including six dipole spiral antenna sections; and
the plurality of delay units including four delay line units, wherein a first delay unit is operable to:
phase shift one of the pair of copies of the positive leg of the outbound RF signal to produce a sixty degree phase shifted representation of the outbound RF signal; and
phase shift one of the pair of copies of the positive leg of the inbound RF signal to produce a sixty degree phase shifted representation of the inbound RF signal;
wherein a second delay unit is operable to:
phase shift another one of the pair of copies of the positive leg of the outbound RF signal to produce a one hundred twenty degree phase shifted representation of the outbound RF signal; and
phase shift another one of the pair of copies of the positive leg of the inbound RF signal to produce a one hundred twenty degree phase shifted representation of the inbound RF signal;
wherein a third delay unit is operable to:
phase shift one of the pair of copies of the negative leg of the outbound RF signal to produce a two hundred forty degree phase shifted representation of the outbound RF signal; and
phase shift one of the pair of copies of the negative leg of the inbound RF signal to produce a two hundred seventy degree phase shifted representation of the inbound RF signal;
wherein a fourth delay unit is operable to:
phase shift another one of the pair of copies of the negative leg of the outbound RF signal to produce a three hundred degree phase shifted representation of the outbound RF signal; and
phase shift one of the pair of copies of the negative leg of the inbound RF signal to produce a three hundred degree phase shifted representation of the inbound RF signal;
wherein the one of the pair of copies of the positive leg of the outbound RF signal provides a zero degree phase shifted representation of the outbound RF signal, wherein the one of the pair of copies of the negative leg of the outbound RF signal provides a one hundred eighty degree phase shifted representation of the outbound RF signal, wherein the one of the pair of copies of the positive leg of the inbound RF signal provides a zero degree phase shifted representation of the inbound RF signal, and wherein the one of the pair of copies of the negative leg of the inbound RF signal provides a one hundred eighty degree phase shifted representation of the inbound RF signal.

15. A radio frequency (RF) front-end module comprises:
an antenna system including:
an antenna structure that includes ‘x’ number of spiral antenna sections, each spiral antenna section of the ‘x’ number of spiral antenna sections transmits a different phase of ‘x’ phases of an outbound radio frequency (RF) signal and receives a different phase of ‘x’ phases of an inbound RF signal, wherein ‘x’ is an integer greater than or equal to two;
an antenna interface operable to:
generate the ‘x’ phases of the outbound RF signal by:
splitting the outbound RF signal into ‘x’ copies of the outbound RF signal; and
phase shifting each of the ‘x’ copies of the outbound RF signal by a respective phase shift to produce the ‘x’ phases of the outbound RF signal; and
combine the ‘x’ phases of the inbound RF signal by:
phase shifting each of the ‘x’ phases of the inbound RF signal by the respective phase shift to produce ‘x’ copies of the inbound RF signal; and
combining the ‘x’ copies of the inbound RF signal to produce the inbound RF signal;
a receive-transmit isolation module operably coupled to the antenna system, wherein the receive-transmit isolation module is operable to isolate the inbound RF signal and the outbound RF signal; and
a tuning module operable to tune the receive-transmit isolation module.

16. The RF front-end module of 15, wherein the antenna interface comprises:
a splitter-combiner module including:
a first layer splitter-combiner unit that is operable to:
split the outbound RF signal into a pair of first layer copies of the ‘x’ number of copies of the outbound RF signal; and
combine a pair of first layer copies of the ‘x’ copies of the inbound RF signal into the inbound RF signal;
a pair of second layer splitter-combiner units, wherein each of the pair of second layer splitter-combiner units is operable to:
split a respective one of the pair of first layer copies of the ‘x’ number of copies of the outbound RF signal into a pair of respective second layer copies of the ‘x’ number of copies of the outbound RF signal; and
combine a respective pair of second layer copies of the ‘x’ copies of the inbound RF signal into a respective one of the pair of first layer copies of the ‘x’ copies of the inbound RF signal; and
a phase shifting module operably coupled to the splitter-combiner module, wherein the phase shifting module includes a plurality of phase delay units, wherein:
a first delay unit of the plurality of phase delay units is operable to:
phase shifting a first one of the ‘x’ copies of the outbound RF signal by a first phase delay to produce a first one of the ‘x’ phases of the outbound RF signal; and
phase shifting a first one of the ‘x’ phases of the inbound RF signal by the first delay to produce a first one of the ‘x’ copies of the inbound RF signal.

17. The RF front-end module of 16, wherein a splitter-combiner unit of the first layer splitter-combiner unit and of the pair of second layer splitter-combiner units comprises:
a first port;
a second port;
a third port;
an impedance circuit element coupled between the second and third ports;
a first quarter wavelength section coupled to the first port and the second port; and
a second quarter wavelength section coupled to the first port and the third port, wherein the second and third ports convey a copy of an RF signal on the first port.

18. The RF front-end module of 16, wherein the first delay unit comprises:
a micro strip phase delay line to provide the first phase delay for a given frequency range.

19. The RF front-end module of 16 further comprises:
a splitter-combiner unit of the first layer splitter-combiner unit and of the pair of second layer splitter-combiner units includes:
a first port;
a second port;
a third port;
a tunable impedance circuit element coupled between the second and third ports;
a tunable first quarter wavelength section coupled to the first port and the second port; and
a tunable second quarter wavelength section coupled to the first port and the third port, wherein the second and third ports convey a copy of an RF signal on the first port; and
the first delay unit including a tunable phase delay line that is adjustable to maintain the first phase delay substantially constant over a broadband frequency range.

20. The RF front-end module of 15, wherein the antenna interface comprises:
‘x’ number of transformers operably coupled to the ‘x’ number of spiral antenna sections, wherein the ‘x’ number of transformers provides the ‘x’ phases of the outbound RF signal to the ‘x’ number of spiral antenna sections and receives the ‘x’ phases of the inbound RF signal from the x′ number of spiral antenna sections;
a plurality of delay units operable to:
phase shift each of the ‘x’ copies of the outbound RF signal by the respective phase shift to produce the ‘x’ phases of the outbound RF signal; and
phase shift each of the ‘x’ phases of the inbound RF signal by the respective phase shift to produce ‘x’ copies of the inbound RF signal;
a plurality of splitter-combiner units operable to:
split the outbound RF signal into ‘x’ copies of the outbound RF signal; and
combine the ‘x’ copies of the inbound RF signal to produce the inbound RF signal.
